(19) United States
(12) Patent Application Publication
(10) Pub. No.: US 2005/0200730 A1
(43) Pub. Date: Sep. 15, 2005

(54) Active pixel sensor array sampling system and method

(76) Inventors: Jeffery Steven Beck, Corvallis, OR (US); William G. Gazeley, Corvallis, OR (US); Matthew Michael Borg, Albany, OR (US)

Correspondence Address: AGILENT TECHNOLOGIES, INC.;Intellectual Property Administration, Legal Department, DL 429, P.O. Box 7599, Loveland, CO, 80537-0599, US

(21) Appl. No.: 10/798,994

(22) Filed: Mar. 11, 2004

(51) Int. Cl. G09G 3/36; H04N 5/217; H04N 9/64; H04N 3/14; H04N 5/335

(52) U.S. Cl. 348/241; 348/243; 348/300; 348/301

(57) ABSTRACT

An active pixel sensor array sampling system provides a differential voltage based upon a sampled video voltage and a sampled reference voltage for each pixel of the array. The system includes a reference and a video circuit for each column of pixels. The video circuits sample all of the column pixel video voltages of each row of pixels together in parallel. The column video voltages of each row of pixels are serially read. The reference amplifier samples and provides a reference voltage as each video voltage is read from the video circuits.

### BACKGROUND OF THE INVENTION

Active pixel sensor arrays, such as may be employed to advantage in CMOS imaging arrays, are well known in the art. The pixels of such arrays are generally arranged in columns and rows. In such arrays, each active pixel generates a pixel voltage having a magnitude related to the intensity of light of an image impinging thereon. The pixel voltages are sampled and ultimately quantized to permit digital storage and/or display of the image. The pixel voltages are generally sampled by a sampling system having a plurality of video circuits which generate a video voltage for each pixel. The video voltages are first sampled and held to be serially read thereafter. More specifically, sampling systems are known which provide a video circuit for each column of pixels and a reset circuit for each row of pixels. The pixel voltages of all of the column pixels of a current row are sampled by the video circuits in parallel. Before the pixels of the next row are sampled, the video voltages derived by the video circuits and from the pixel voltage of the pixels of the current row are serially read from the video circuits. As each video circuit is read, its video voltage is made available along with a reference voltage. The video and reference voltages may be provided to a differential amplifier. The differential amplifier output may then be utilized for quantization and ultimate storage or display.

In the prior art, the same reference voltage was provided for all of the pixels of a row of pixels. Hence, a reference voltage was generated only once for each row of pixels. This means that the noise sampled on the reference amplifier is fixed for each row. If the noise variance is significant, the visual effect is manifested as a row-wise noise. The result can be a horizontal stripe or stripes in the final image visible to the human eye.

The present invention eliminates the row-wise noise generated by active pixel sensor array sampling systems of the prior art. As will be seen hereinafter, the row-wise noise is eliminated by the sampling of a separate reference voltage as the video voltage of each video circuit is read.

### SUMMARY OF THE INVENTION

In accordance with one aspect of the present invention, an active pixel sensor array sampling system includes a video circuit that generates a video voltage from each one of a group of pixels, and a reference circuit that generates a unique reference voltage associated with each one of the pixels in the group of pixels. The video circuit comprises a plurality of video amplifiers, each video amplifier being associated with a respective one of the pixels in the group of pixels, the reference circuit comprises a single reference amplifier associated with all of the pixels in the group of pixels, and wherein the reference amplifier samples and holds a unique reference voltage for each one of the pixels in the groups of pixels.

The pixels may be arranged in columns and rows. Each of the video amplifiers may be associated with all of the pixels in a respective column of pixels.

The system may further include a differential amplifier that generates a differential voltage responsive to the video voltage and the unique reference voltage associated with each pixel. The reference amplifier has an output which may be continuously coupled to the differential amplifier during reading of the video voltage of each of the video amplifiers.

The reference amplifier may have an output continuously coupled to the differential amplifier during the reading of the video voltage of each video amplifier.

In accordance with a further aspect of the present invention, an active pixel sensor array sampling circuit samples a voltage on each one of a plurality of pixels. The system comprises a plurality of video circuits, each video circuit generating a video voltage related to a voltage on a respective one of the pixels as its respective pixel is sampled and a reference circuit that samples a reference voltage as each video voltage is read from the video circuits.

In accordance with a still further aspect of the present invention, the invention provides an integrated circuit including an active pixel sensor array sampling system. The integrated circuit comprises a plurality of video circuits, each video circuit sampling a video voltage from each one of a group of pixels and a reference circuit that samples a unique reference voltage as each video voltage is read from the video circuits.

In accordance with further aspects of the present invention, the invention provides a method of sampling a group of active pixels. The method comprises sampling a voltage on each pixel to generate a video voltage for each pixel, serially reading each video voltage, and sampling a reference voltage as each video voltage is read.

### BRIEF DESCRIPTION OF THE DRAWINGS

The foregoing aspects and many of the attended advantages of this invention will become more readily appreciated as the same become better understood by reference to the following detailed description, when taken in conjunction with the accompanying drawings, wherein:

FIG. 1 is a block diagram of an active pixel sensor array sampling system according to an embodiment of the present invention;

FIG. 2 illustrates a series of waveforms of control signals which may be utilized in the system of FIG. 1; and

FIG. 3 is a circuit diagram of a video or reference amplifier of FIG. 1.

### DESCRIPTION OF THE INVENTION

The following discussion is presented to enable a person skilled in the art to make and use the invention. The general principles described herein may be applied to embodiments and applications other than those detailed below without departing from the spirit and scope of the present invention. The present invention is not intended to be limited to the embodiments shown, but is to be accorded the widest scope consistent with the principles and features disclosed or suggested herein.

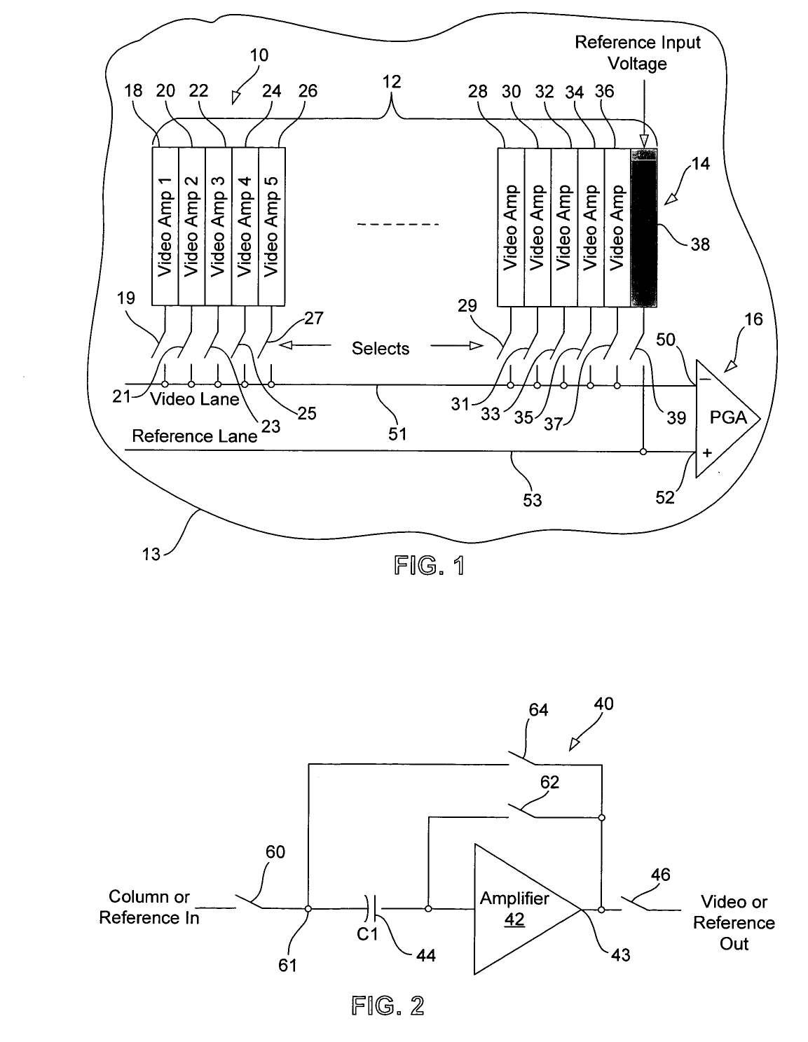

FIG. 1 is a block diagram of an active pixel sensor array sampling system embodying the present invention. The system 10 may be integrated within an integrated circuit 13. The integrated circuit 13 may be a CMOS integrated circuit. The system 10 of the integrated circuit 13 generally includes a video circuit 12, a reference circuit 14, and a differential amplifier 16. The video circuit 12 includes a plurality of video amplifiers. Each video amplifier is associated with a column of pixels. To that end, FIG. 1 illustrates video amplifiers 18, 20, 22, 24, 26, 28, 30, 32, 34, and 36. Each of the video amplifiers is selectively coupled to an input 50 of the differential amplifier 16 by switches 19, 21, 23, 25, 27, 29, 31, 33, 35, and 37. As will be appreciated by those skilled in the art, the video circuit 12 will include many more video amplifiers and hence pixel columns than illustrated in FIG. 1 in a practical array.

The reference circuit 14 preferably includes a single reference amplifier associated with all rows of pixels. The reference amplifier provides a unique reference voltage as the video voltages derived from each pixel of a row of pixels is read from the video amplifiers. The reference amplifier 38 is selectively coupled to an input 52 of the differential amplifier 16 by a switch 39.

The input 50 of the differential amplifier is coupled to a video lane 51 to which the video amplifiers are selectively coupled. The input 52 of the differential amplifier 60 is coupled to a reference lane 53 to which the reference amplifier is selectively coupled. The differential amplifier 16 is preferably a programmable gain amplifier.

Referring now to FIG. 2, it illustrates a circuit diagram of a circuit 40. Each of the video amplifiers and the reference amplifier shown in FIG. 1 may be configured as the circuit 40 of FIG. 2. The circuit 40 includes an amplifier 42, a capacitor 44, a switch 46, and switches 60, 62, and 64. The switch 46 corresponds to the switches 19, 21, 23, 25, 27, 29, 31, 33, 35, 37, and 39 shown in FIG. 1, each of which selectively couples its associated video or reference circuit to its appropriate video lane or reference lane.

When a pixel output is to be sampled and held as a video voltage or when a reference voltage is to be sampled and held, switch 60 is initially closed to input the pixel or reference voltage as the case may be. Switches 62 is also closed and switch 64 is opened. Switch 46 is open for the meantime as well.

With switch 62 closed, the amplifier 42 is caused to be in unity gain feedback. Hence, there is no gain around the amplifier 42. The output of the amplifier 42 is fed back to the input and remains at a constant common mode level.

When a pixel or reference voltage is brought in to node 61, it appears at one of the plates of capacitor 44. Now, a charge is on capacitor 44 which is equal to the voltage difference across the capacitor which is the inputted pixel or reference voltage on one side and the common mode level of the amplifier 42. That voltage multiplied by the capacitance value of capacitor 44 is the charge across the capacitor 44.

Next, switch 62 is opened. This causes the input to be sampled. The charge on capacitor 44 cannot now be changed because there is no DC path for charge to leak on the amplifier side of capacitor side 44.

Next, switch 60 opens to disconnect input node 61 from the amplifier circuit. Now, both sides of capacitor 44 are floating so that again, no charge can be lost from the capacitor 44. The sampling of the pixel voltage or reference voltage is now complete.

When the video voltage derived from the pixel voltage or the reference voltage is to be read from circuit 40, switch 64 is closed. This completes the connection from the input side of capacitor 44 to the output 43 of amplifier 42. This causes the output 43 of amplifier 42 to be identical to the voltage that was at input node 61 during the sampling period.

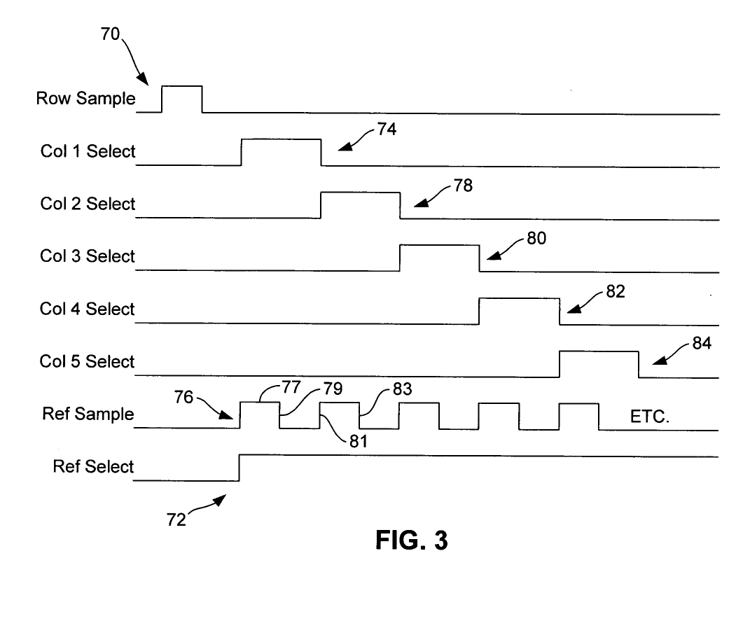

FIG. 3 illustrates control signals which may be employed in the operation of the system of FIG. 1 as the video voltages derived from a row of pixels are read from the video amplifiers in series, one at a time. The first waveform 70 shows a row sample control signal which is sent to each of the video amplifiers. The row sample control signal causes the pixel voltage of each pixel of the row of reference amplifier 38 to be sampled and held as a video voltage by a corresponding one of the video circuits.

With the pixel voltages of all of the column pixels of the row now having been sampled and held, the serial reading of the video voltages occurs next. Accordingly, the reference select signal 72 closes switch 39 to couple the output of reference circuit 38 to the reference lane 53 of the differential amplifier 16. With reference amplifier 38 thus connected to the reference lane 53, the video circuits are serially read. Hence, the pixel of column 1 is first read upon receipt of signal 74. Signal 74 causes the read switch (switch 64 of FIG. 2) to close to transfer the pixel voltage of the first column pixel to its output. The signal 74 also causes switch 19 to be closed to transfer the video voltage derived from the pixel of column 1 to the video lane 51. Each of the video circuits is read serially as illustrated by the serial occurrence of control signals 78, 80, 82, and 84 which continue until all of the video circuits are read.

As may also be noted in FIG. 3, as the video voltage of each video circuit is read, the signal 76 causes the reference circuit 38 to sample and hold a new and unique reference voltage for placement on the reference lane 53 with the read video voltage. More specifically, when the video voltage derived from the column 1 pixel is read, the reference sample and hold signal 76 first goes high at 77 to cause the reference circuit to sample the reference voltage and then goes low at 79 to read that reference voltage onto the reference lane 53. As the video voltage is read from the video circuit associated with the second column pixel, the reference circuit once again reads a unique reference voltage when the waveform 76 goes high at 81 and then transfers that reference voltage to the reference lane when the control signal 76 goes low at 83. Hence, as may be seen from the foregoing, the reference circuit 38 generates a new reference voltage every time a video voltage is read from a video circuit and transferred to the video lane 51.

While particular objects and advantages of the present invention have been shown and described in the illustrated embodiments, modifications may be made, and it is therefore intended in the appended claims to cover all such changes and modifications which fall within the true spirit and scope of the invention.

1. An active pixel sensor array sampling system comprising:
a video circuit that generates a video voltage from each one of a group of pixels; and
a reference circuit that generates a unique reference voltage associated with each one of the pixels in the group of pixels; wherein the video circuit comprises a plurality of video amplifiers, each video amplifier being associated with a respective one of the pixels in the group of pixels, wherein the reference circuit comprises a single reference amplifier associated with all of the pixels in the group of pixels, and wherein the reference amplifier samples and holds a unique reference voltage for each one of the pixels in the group of pixels.

2. The system of claim 1 wherein each of the video amplifiers is associated with all of the pixels in a respective column of pixels.

3. The system of claim 1 further comprising a differential amplifier that generates a differential voltage responsive to the video voltage and the unique reference voltage associated with each pixel.

4. The system of claim 3 wherein the reference amplifier has an output continuously coupled to the differential amplifier during reading of the video voltage of each of the video amplifiers.

5. An active pixel sensor array sampling circuit that samples a voltage on each one of a plurality of pixels, the circuit comprising:
a plurality of video circuits, each video circuit generating a video voltage related to a voltage on a respective one of the pixels as its respective pixel is sampled; and
a reference circuit that samples a reference voltage as each video voltage is read from the video circuits.

6. The circuit of claim 5 wherein the pixels are arranged in columns and rows, wherein the reference circuit is associated with all of the pixels of each row of pixels, and wherein the reference circuit samples and holds a unique reference voltage as each video voltage of a row of pixels is read.

7. The circuit of claim 6 further comprising a differential amplifier that provides a differential voltage representing a difference between each read video voltage and each sampled reference voltage.

8. The circuit system of claim 7 wherein the reference amplifier has an output continuously coupled to the differential amplifier during the reading of the video voltages for each row of pixels.

9. The circuit of claim 8 wherein each video amplifier is associated with all of the pixels of a respective column of pixels.

10. An integrated circuit including an active pixel sensor array sampling system comprising:
a plurality of video circuits, each video circuit sampling a video voltage from each one of a group of pixels; and
a reference circuit that samples a unique reference voltage as each video voltage is read from the video circuits.

11. The integrated circuit of claim 10 further comprising a differential amplifier that generates a differential voltage responsive to each read video voltage and its corresponding sampled reference voltage.

12. The integrated circuit of claim 11 wherein the pixels are arranged in columns and rows and wherein each video circuit is associated with all of the pixels of a respective column of pixels.

13. A method of sampling a group of active pixels comprising:
sampling a voltage on each pixel to generate a video voltage for each pixel;
serially reading each video voltage; and
sampling a reference voltage as each video voltage is read.

14. The method of claim 13 comprising the further step of generating a differential voltage from each read video voltage and its associated sampled reference voltage.

15. The method of claim 14 comprising the further steps of arranging the pixels in plural groups, and providing a single reference amplifier for all of the groups of pixels.

16. The method of claim 15 wherein the pixels are arranged in columns and rows, and wherein each group of pixels is a row of pixels.
